(19) United States
(12) Patent Application Publication
(10) Pub. No.: US 2007/0111152 A1
(43) Pub. Date: May 17, 2007

(54) Pre-cemented orthodontic appliances

(76) Inventors: Carolyn M. Primus, Bradenton, FL (US); Michael C. Alpern, Port Charlotte, FL (US)

Correspondence Address: CHARLES J. PRESCOTT, P.A., SUITE 115, 2033 WOOD STREET, SARASOTA, FL, 34237, US

(21) Appl. No.: 11/649,666

(22) Filed: Jan. 4, 2007

Related U.S. Application Data
(63) Continuation-in-part of application No. 11/214,152, filed on Aug. 29, 2005.
Application No. 11/214,152 is a continuation-in-part of application No. 11/069,303, filed on Mar. 1, 2005, now abandoned.

(51) Int. Cl. A61C 3/00

(52) U.S. Cl. 433/9

(57) ABSTRACT

An orthodontic appliance and method of pre-applying two dental restoratives thereto of specific viscosities, the appliance including a main body having a bonding tooth-facing surface and retentive elements disposed over a tooth-facing bonding surface. The first dental restorative is applied onto the tooth-facing surface and retentive elements, the first dental restorative having a very low viscosity and being flowable and thus capable of fully penetrating into the retentive elements and being cured therein. The second dental restorative is applied over the cured first dental restorative and left uncured, the second dental restorative having a viscosity substantially higher than that of the first adhesive composition and being highly bondable to the cured first dental restorative and a tooth surface when later cured. The bracket having both the cured and uncured dental restoratives applied thereto is packaged and ready for direct or indirect bonding to teeth.

### CROSS-REFERENCE TO RELATED APPLICATIONS

This application is a continuation-in-part of U.S. application Ser. No. 11/214,152 filed Mar. 25, 2006 which is a continuation-in-part of U.S. application Ser. No. 11/069303 filed Mar. 1, 2005.

### STATEMENT REGARDING FEDERALLY SPONSORED RESEARCH OR DEVELOPMENT

Not applicable

### INCORPORATION-BY-REFERENCE OF MATERIAL SUBMITTED ON A COMPACT DISC

Not applicable

### BACKGROUND OF THE INVENTION

1. Field of the Invention

This invention relates generally to pre-cemented dental articles and particularly to orthodontic articles. More specifically, the present invention relates to dental articles that have been pre-cemented with dental materials of various viscosities to enable direct or indirect bonding of orthodontic appliances onto teeth.

2. Description of Related Art

Orthodontics is the science of placing teeth into the proper occlusal orientation and generally uses brackets, tubes and bands to gradually force teeth into a corrected configuration. The apparatus usually includes tightly applied wires strung between appliances (brackets, tubes or bands) placed on the buccal/labial or lingual surfaces of teeth. The appliances must be attached to the teeth firmly enough to hold the wires and to withstand the stresses exerted during tooth movement. However, the bond cannot be so strong as. to make it too difficult to remove the appliance after treatment without damaging the tooth surface.

Orthodontic brackets, tubes and bands have a tooth-facing surface designed with retentive means for adherence to a tooth. The tooth-facing surfaces of the appliances often have complex curvatures to conform to the teeth on which they are placed. The tooth-facing surfaces of such appliances may be made of the same material as the outer-most surface of the bracket that faces the lingual, labial or buccal anatomy on the opposite non-tooth-facing surface. Materials used for orthodontic appliances include a variety of stainless steel alloys (such as 303 or 17-4), titanium or its alloys, cobalt chrome alloys, polycarbonate polymer, or ceramics such as alumina or zirconia. Both single crystal alumina (sapphire) and polycrystalline alumina are used. Alternatively, the brackets may be some combination of these materials.

For metal brackets, some kind of mesh or undercut base is commonly used as shown in FIGS. A and B. In other cases, roughening of the bracket's base surface is used which can be achieved by etching, sand-blasting, shot-peening, ion beam etching or reactive ion etching on the tooth contact surface of the appliance (Sachdeva and Oshida RE35,863) to make retentive elements. For ceramic brackets, sometimes the base is smooth, or etched or otherwise prepared to have microscopic roughness. Alternatively, the ceramic appliances are undercut as in FIG. C, and sometimes the appliances have pockets or other indentations for increased surface area for bonding, as illustrated in FIG. D. Any of these methods are used or combined to enhance bonding of the appliance to the tooth for the treatment duration. Each design creates macroscopic or microscopic areas for mechanical retention and enhanced surface area contact of the cement bonded to the base. Intimate contact of the cement with the microscopic or macroscopic undercuts from the roughness, mesh, undercuts, indentations, or other designs is essential for bonding.

A cement is placed on the appliance's tooth-facing surface and should retain the appliance to the tooth. When the cement is cured, the cement is locked into the appliance's retentive elements on its tooth-facing surface by mechanical and/or chemical adhesion. Commonly, cement is placed on these devices by the orthodontist or an orthodontic assistant, and then the appliance is pressed onto the tooth by the orthodontist. Resin cement, glass ionomers cements, or combinations thereof, are used for orthodontic bonding, with self-cure, light-curing, or combined modes of curing. The challenge has been to have enough bonding strength to make the appliance adhere to the tooth for the desired treatment, including changes of wires, over a period or months or years. This orthodontic appliance should ultimately be removable from the tooth after treatment without enamel fracture or damage to the tooth.

Previously, orthodontic cements have been designed as a compromise. A low viscosity is needed to flow and penetrate the mesh, microscopic or macroscopic undercuts, or roughness on an appliance. However, a high-viscosity cement is needed for placing appliances intra-orally to prevent drifting of the appliances before the cement sets on the tooth.

The challenge for designing a single cement for orthodontic appliances has become more difficult because orthodontic appliances have become smaller in size to increase the distance between brackets. This larger distance permits orthodontic wires the span to flex, but requires higher strength per unit area of the cement to the tooth and the appliance.

To apply cement, the orthodontic assistant must grasp a small orthodontic appliance, such as a bracket, using a bracket holder, and apply the cement (“butter the appliance”) onto the tooth-facing surface of an orthodontic appliance for bonding. The assistant is under a time constraint because the orthodontist is trying to maintain a dry tooth in the patient's mouth. A dry field can only be maintained for a short period of time before the patient produces saliva, which can interfere with bonding. Additionally, orthodontic cements are either chemically (self-cured) or light-cured by application of intense blue light to activate polymerization, so that the cement is curing as the assistant is applying the cement and trying to force it evenly and completely over the tooth-facing surfaces into the retentive elements. If air gaps remain between the tooth-facing retentive elements and the cement, the bond may be insufficient for the stresses of orthodontic treatment.

Most orthodontic appliance failures occur due to failure of the clinician or clinical assistants to physically force orthodontic bonding cements into the retentive features of appliances. Even the most skilled assistant or clinician will not be able to adequately force enough resin or cement into the retentive elements of every appliance. The result is bracket bonding failures either during the securing or the arch wire into the appliance, or shortly thereafter. Any failure is stressful and time-consuming to the patient and the orthodontic team members.

When an appliance is displaced from the tooth surface during treatment, time is lost to the clinician, and treatment is slowed for the patient. A special emergency appointment is required to replace the cemented appliance. The patient must return to the office, the individualized arch wire must be removed in the area of the failure, the tooth cleaned, re-etched, washed, dried and a new appliance cemented in place. Then the arch wire must be re-ligated or reattached to every tooth. After this, accessories such as elastics are placed into position again.

A high-viscosity cement does not flow easily into the retentive elements of an orthodontic appliance and the good mechanical adhesion to the device cannot be achieved. A single low-viscosity cement that permits easy flow into the roughness, undercuts or mesh, will have physical behavior that proves to be a detriment when the clinical orthodontist attempts to accurately position the orthodontic bracket onto the tooth. Too much flow of the cement causes the appliance to be difficult to position accurately. As soon as the ideal position is found, the appliance may drift out of its desired position. With low-viscosity cements it is difficult to place and hold the orthodontic appliance in the precise position on the tooth while the cement is cured and the appliance is stabilized. Furthermore, the dental literature indicates that some flowable materials have insufficient shear bond strength for use in orthodontics. (Uysal et al, Angle Orthodontics Vol 74, No 5 p 694 2004.)

Another technique is used by some orthodontists, other than the direct technique described above. Some clinicians are proponents of the indirect technique where the brackets are placed on a model of the patient's teeth and then transferred to the patient's mouth. The appliances are cured on a model of the patient's mouth. The appliances must adhere to the model after curing well enough to allow a device to be formed over them to transfer to a patient's mouth. However, the appliances must not adhere to the model so well that they cannot be removed, or that part of the model is removed when the appliance is separated from the model. A separating liquid is applied to the model to help remove the bracket from the model for the latter situation. For the former, an unfilled resin adhesive may be used.

In the indirect application case, the brackets are “buttered” with a temporary adhesive or dental adhesive and placed on the model and the cement is cured. The bracket pad now has the shape or form of the patient's tooth. A “tray” is formed around the brackets on the model and the tray is used to remove the “set” brackets to be transferred to the patient's mouth. Cement is applied to the brackets in the tray before they are placed, as a group in the tray, into the patient's mouth and onto the patient's teeth. This cement is allowed to set, either by light-curing or self-curing inter-orally. Then the tray that held the brackets in place is removed, leaving the brackets on the teeth, accurately positioned. This saves chair time for the clinical orthodontist. Furthermore, the indirect technique can allow the clinician to place the brackets more accurately because the model can be viewed from many angles, including a view from the palatal side looking over the incisal or occlusal surfaces or upwards from the gingival area.

Jordan et al (U.S. Pat. No. 6,482,002 B2) report an appliance with a slot to allow better light penetration to the cement under the cement of a bracket, and ensure the highest curing of light-cured cement. Kesling (U.S. Pat. No. 6,685,468 B1) teaches a polymer-resin bonding base on an orthodontic bracket. In U.S. Pat. No. 6,746,242 B1 Kesling teaches about cured and uncured layers of the same material. In U.S. Pat. Nos. 5,098,288 and 5,263,859, Kesling teaches about a flexible bonding pad for easier debonding of orthodontic brackets.

Devanthan (U.S. Pat. No. 6,749,426) teaches about a pad with a light-curing adhesive, especially for posterior teeth where higher bond strength is needed. He made separate or integrated pads using silane and acrylocopolymers with another layer of light curable cement. The light-curing adhesive does not flow into the mesh. Dwight and Jacobs invented a packaged element that prevents the ingress of visible light into a covered recess onto an element with a light-curable cement. The cover is a flexible polymeric film in contact with the substrate. Brennan and Hansen in U.S. Pat. No. 6,183,249 teach a release substrate on a bracket, which has adhesive. The release substrate is suitable for low-viscosity viscosity adhesives. The release substrate has pores and is used with precoated orthodontic appliances.

Randklev in U.S. Pat. No. 5,015,180 invented a dental tape with a light-curable paste placed between two cover sheets. The tape is applied to the appliance's base and supplied with a cover sheet.

Adam and Forbes in U.S. Pat. No. 6,060,815 invented an orthodontic article with a lyophilic ionic cement to overcome shelf life problems and deterioration of bond strength to teeth. This patent relies on freeze-drying glass-ionomer cement, zinc oxide cements or calcium hydroxide and activating the cement by the addition of a liquid.

Nikutowski and James in U.S. Pat. No. 6,528,555 invented an adhesive for pre-coating onto orthodontic brackets that changes color after exposure to light. Khachatoorian et al teach a syringe assemble for applying bonding agents to orthodontic bands in U.S. Pat. No. 6,238,212. Lemchem in U.S. Pat. No. 5,890,892 invented a bracket with a partially-cured denture-base type of material that is molded to the tooth surface with a thin layer of adhesive.

Wong in U.S. Pat. No. 5,810,584 teaches about an orthodontic appliance that has a pre-applied applied adhesive with a non-tacky surface through the application of particles to extend its shelf life. This concept is very dependent on the primer to wet the adhesive-particle surface when placing the bracket. No additional adhesive is used over the particle-embedded embedded surface; only the primer is used to create the bonding surface. Wong teaches a two-paste system, so that a light-curing paste in the first layer can be more completely cured.

Wong also invented a plastic orthodontic bracket, U.S. Pat. No. 5,295,824, with an acrylic primer for enhanced bonding. He refers to shelf stability of several weeks and a polycarbonate bracket. The primer is acrylic and a method is described. Tuneberg invented a plastic orthodontic bracket also in U.S. Pat. No. 5,267,855, with a special base with textured particles. The particles create a mechanical interlock and create higher bonding strength in sheer and tensile modes.

In U.S. Pat. No. 5,897,312 the adhesion of polycarbonate brackets is improved. An adhesive is applied to the base of a polycarbonate bracket and cured. Next the bracket is heated with a microwave to further enhance the adhesion of the cement to the bracket. Masuhara et al in U.S. Pat. No. 5,147,202 disclose a bracket made of composite resin and a dental adhesive or polymethacrylate. The thin layer on the bonding surface is suitable for application of a cement, but does not substitute for the application of cement to bond the device.

In U.S. Pat. No. 6,120,288 Deslauriers invented a device for immobilizing the mandible with a cloth-like body and adhesive. The device is not suited for orthodontic treatment for misaligned teeth. In U.S. Pat. No. 4,204,325 an adhesive patch is disclosed for application to orthodontic brackets. The adhesive has an activator applied and can also be deactivated for removal.

Glass-ionomer (U.S. Pat. No. 6,050,815) or resin-based adhesive (U.S. Pat. No. 5,015,180) cements have been used for precoated orthodontic articles but compomer restorative materials and composite restorative materials have not. Farzin-Nia (U.S. Pat. No. 5,480,301) teaches the application of silica for retention and silanation, and also providing a greater mechanical interlock for bond strength.

Chester et al (U.S. Pat. No. 5,328,363) invented a packaged dental article with an adhesive. The package includes a dental appliance with adhesive placed on a flexible film. Yi et al tested the shear bond strength of direct and indirectly bonded brackets and determined averages of 1,580 and 1,625 psi respectively.

Yi stated that orthodontic brackets must be able to sustain 850 to 1130 psi. Uysal et al tested flowable composites for orthodontic bracket bonding and determined that these materials were not suitable because of the lower shear bond strength. They measured shear bond strength for flowable composites of 960 to 1,280 psi versus 2,481 psi for conventional brackets with an orthodontic cement. However, the state of the teeth (dry/moist, autoclaved, freshly extracted) being tested is crucial to the test results-determined. Comparisons are best made among identically prepared teeth.

“The inability of visible light to cure material behind the bracket mesh may be responsible, in part, for the site of failure. Polymerization of light-curing materials for orthodontic bonding, even with longer illumination times, does not result in the same degree of polymerization that is obtained by direct illumination. Air entrapment behind the mesh of a metal bracket may also significantly affect polymerization, because of the role of oxygen inhibition of free radical polymerization, and may produce lower bond strength between the bracket mesh and the composite material.”¹ For the present invention, the adhesive/restorative in the base of the bracket is cured before being placed on the tooth and avoids problems of light penetration from the side into the obscuring mesh or undercuts.
The Angle Orthodontist: Vol. 73, No. 1, pp. 56-63 Bond strength of Orthodontic Brackets Using Different Light and Self-curing Cements Manuel Toledano, MD, BDS, PhD; Raquel Osorio,LDS, PhD; Alejandro Romeo LDS, PhD, Blanca de la Higuera, PhD; Franklin Garcia-Godoy, DDS,MSc

Brennan in U.S. 2005/0136370 published Jun. 23, 2005, does not teach a very high and a very low viscosity adhesive or restorative material. Brennan wrote an article about viscosity and mentioned the materials cited in her patent application. The viscosities she published are about 600 and 1800 Pa·s and she practices with a wider mesh (˜200 mesh) bracket or a ceramic bracket with undercuts. Brennan's viscosities are suitable for mesh penetration but not for lack of drifting. Furthermore, low viscosity adhesives were considered prone to cohesive failure when used at the single adhesive, which may be because of bubbles, but to our surprise, were very effective as the inner adhesive within the bracket base. “A new flowable composite, DENFIL FLOW, has shown an acceptable shear bond strength for bonding orthodontic brackets, when used with an intermediate, unfilled, low-viscosity resin. According to the manufacturer, it also shows a good viscosity for use with no preliminary adhesive. This could reduce the total time of bonding procedure while maintaining clinically useful bond strength. The aim of the current research was to assess this property. Eighty extracted human premolars were randomly divided into four equal groups. Stainless steel brackets were bonded to etched enamel using (1) DENFIL FLOW, (2) a traditional flowable composite (DYRACT-FLOW), (3) DENFIL FLOW composite resin and an intermediate liquid resin, and (4) TRANSBOND XT adhesive. Debonding was performed with a shearing force. The residual adhesive on the enamel surface was evaluated using the adhesive remnant index. The bond strength of DENFIL FLOW (34.8 MPa) showed no significant difference with the other control groups and was clinically acceptable. DENFIL FLOW and DYRACT FLOW tended to display cohesive failure within the adhesive. DENFIL FLOW can be used without liquid resin to reduce the bonding procedure time while maintaining acceptable bond strength. Further studies are required to evaluate the enamel surface of the teeth after the same polishing procedure in the four groups.”²
The Angle Orthodontist: Vol 74, No. 5, pp, 697-702. Are the Folwaable Composites Suitable for Othodontic bracket Bonding? Tancan Uysal, DDS; Zafer Sari, DDS PhD; Abdullah Demir, DDS, MS

“A new dental flowable composite, DENFIL FLOW, was evaluated for the bonding of orthodontic brackets by determining its shear bond strength (SBS) and the mode of bond failure after debonding. Eighty extracted human premolars were divided into two equal groups. Metal brackets were bonded to etched enamel using a composite resin control (Transbond XT) or DENFIL FLOW. After 72 hours of incubation in saline solution at 37° C., debonding was performed with a shearing force. The SBS and the mode of bond failure were examined. In addition, representative samples from each group were examined by scanning electron microscopy (SEM). No significant difference was observed in the SBS between the groups, and a clinically acceptable SBS was found for the two adhesives. Bond failures occurred mostly in the bracket-adhesive interface, without significant differences between the groups. At SEM analysis, DENFIL FLOW showed a greater frequency of air bubbles within the resin than did TRANSBOND XT. In conclusion, DENFIL FLOW displayed the same SBS as traditional composite resins and similar bond failures. For the present invention, bubbles in the low viscosity cement would not occur because it is flowed into the base and cured and not used between the base and the tooth interface.”³
The Angle Orthodontist: Vol. 75, No. 3, ppg 410-415; Shear Bond Strength, Bond Failure and Scanning electron Microscopu Analysis of a New Flowable Composite for Orthodontic Use; Michele D'attilio, Tonino Traini, Bonato Di Iorio,Giuseppe Varvara; Felice Festa; Simona Tecco.

“The use of flowable composites is not advocated for orthodontic bracket bonding because of significantly lower SBS values achieved. By the combination of adhesives of the present invention, sufficient shear bond strength has been achieved. These findings revealed that the flowable composites did not bond to the bracket base as effectively as did the control group. Most of the failures of the flowable composites were at the bracket-adhesive interface, but the enamel-adhesive interface was fine. It was believed that possibly a different bracket base may adhere better, or the use of a composite custom base as used in indirect bonding may overcome this weak point. If so, this would make flowable composites unsuitable for direct bonding but possibly suitable for indirect bonding. The first dental restorative of the present invention is “flowable”.⁴
The Angle Orthodontist: Vol 74, No. 3, pp. 400-404. The Effect of Variation in Mesh-Base Design on the Shear Bond Strength of Orthodontic Brackets; Samir Bishara, BDS, DDS, Dortho, MS; Manal M. A. Soliman, BDS, MS; Charuphan Oonsombat, DDS, MS; John F. Laffoon, BS; Raed Ajlouni, BDS, MSe

“Finally, the quality of orthodontic attachment is influenced by the geometry of the bracket-cement interface. This is primarily determined by the flow of orthodontic cement into the undercuts provided by the bracket base. The degree of penetration will determine the dimensions and physical properties of the resin tags, and any areas of incomplete penetration could lead to stress concentrations and reduced interfacial strength. The primary determinants of cement flow stress concentrations and reduced interfacial strength. The primary determinants of cement flow are the penetration coefficient of the cement, determined by surface chemistry and the pressure of application. In addition, employing Poiseille's law for the flow of a Newtonian fluid, it can be demonstrated that fluid penetration is proportional to the square root of time, implying that low viscosity cements with long working times will penetrate into pores more readily than high-viscosity cements with short working times. It is essential to use a very low-viscosity material for a fine mesh bracket or for any device with undercuts.”⁵ Furthermore, it is essential to avoid any pores on the surface of the bracket with the adhesive and the low viscosity material described in the present application achieves that goal. If pores are present, the bonding strength is effectively reduced.
The Angle Orthodontist: Vol. 70, No. 3, pp. 241-246. The influence of Orthodontic Adhesive Properties on the Quality of Orthodontic Attachment; Jeremy Knox, BDS, MScD, PhD, Morth RCS, FDS; Malcolm L. Jones, BDS, MScD, PhD, FDS, Dorth RCS; Pierre Hubsch, Depl-ing. PhD; John Middleton, BSc, MSc, FRSAd.

“It becomes critical to press the bracket after it is placed on the tooth to force the adhesive to pass through the mesh layer(s) and minimize the amount of air trapped in the mesh, enhancing bond strength.”⁶ In the present invention, we have eliminated the need for the clinician to press the bracket to penetrate the mesh; it's done automatically by a proper low-viscosity dental restorative.
The Angle Orthodontist; Vol 74, No. 3, pp. 400-404. The Effect of Variation in Mesh-Base Design in the Shear Bond Strength of Orthodonitc Brackets; Samir Bishara, BDS, DDS, Dortho, M S; Manal M. A. Soliman, BDS, M S; Charuphan Oonsombat, DDS, M S; John F. Laffoon, BS; Raed Ajlouni, BDS, MSe

In U.S. Pat. No. 4,889,485 a multi-layer mesh is described, which is also depicted in this application. The mesh size in this patent is as fine as 400 mesh, which is a much finer opening or undercut than found with other devices, such as the Victory Brackets or the ceramic brackets by Brennan. The difficulties of mesh penetration are much higher for brackets with this patented mesh. The finer mesh increases the undercut area and the metal-adhesive bonding area.

### BRIEF SUMMARY OF THE INVENTION

The present invention provides a dental article and system for application having a combination of cements on orthodontic appliances including multiple layers that enable bonding to teeth by the direct or indirect methods, and methods of making such articles. Thus, for the first time, use of differing existing products solves the flow problem of physically forcing a cement into the tooth-facing surface of orthodontic appliances having retentive elements such as surface roughness, indentations, undercuts, or mesh to achieve a mechanical and chemical bond to the base thus assuring that the primary reason for orthodontic bracket failure (failure between the cement and orthodontics appliance) is eliminated.

In the present invention, a combination of light-curing and self-curing dental restorative composite materials is used. One of these restoratives is preferably a compomer material that contains glass-ionomer and resin composite materials. Such materials must be protected from moisture and light. If exposed to moisture, the glass-ionomer component begins to cure. If exposed to light, the resin components begin to cure. In the present invention the preferred embodiment is for the manufacturer to apply and cure the compomer as the first layer. Alternatively, a low-viscosity, self-curing glass-ionomer cement or flowable composite may be used.

On top of the first layer is placed a resin restorative material or a resin cement, which must be protected from direct light. This enables a bond to the brackets and a long shelf life appliance that can be bonded to the tooth.

The first layer is preferably applied and cured before seeing the patient. The second layer may be applied just before the appliance is placed on the patient's tooth, or may be pre-applied. If pre-applied, the resin material must be applied in the absence of actinic radiation. If pre-applied, it is imperative that the pre-cemented article be protected from actinic radiation that initiates the curing of the resin material.

This invention combines bonding to, and penetration of the retentive elements used on brackets, bands or other orthodontic appliances. Furthermore, time is saved for the patient with the orthodontic clinician by not having a dental assistant force the cement into the retentive elements of an appliance before application by the direct technique. Furthermore, the cement in contact with the tooth is of a suitable viscosity to insure accurate placement without drifting as the appliance is placed and the cement is cured. Furthermore, the cement is pre-bonded to the appliance into the retentive elements so that the second layer of material adheres to the first and no special requirements for retentive elements are needed between the materials. Therefore, the full bond strength is developed more quickly than normally and the arch wires may be placed sooner. The result is that a clinician has fewer bonding failures, the brackets and bands are more easily placed by the direct or indirect method, and improved bonding is provided.

The present invention saves the clinician the time and worry of applying cement and gives a more consistent bond to teeth. It overcomes the difficulty of having a cement that has a low enough viscosity to bond to the appliance and high enough viscosity to bond to the tooth without drifting. The bonding strength of the appliance to the tooth is developed more quickly than with more slowly cured and thicker layers of cements. Using materials usually indicated for restoratives leads to a more effective bonding system. Using two materials, one cured and one non-cured leads to a more effective bonding system.

Furthermore, the present invention combines two fluoride-releasing materials into the pre-cemented bracket. Fluoride release is considered beneficial to prevent decay or decalcification, which is common with wearers of orthodontic brackets, due to the difficulty of cleaning around the appliances.

The present invention also affords a rapid development in strength of the bond between the appliance and the tooth surface, which enables a larger, more full slot-filling wire to be placed immediately to accelerate or shorten treatment time. For instance, a normal nickel-titanium wire may be placed without waiting at least fifteen (15) minutes or more for the prior art cement to achieve at sufficient strength.

In accordance with these and other objects which will become apparent hereinafter, the instant invention will now be described with reference to the accompanying drawings.

### BRIEF DESCRIPTION OF THE SEVERAL VIEWS OF THE DRAWING(S)

FIGS. A to D are prior art dental bracket features

FIG. 1 is a broken end view of a typical dental bracket or appliance.

FIG. 2 is a view of FIG. 1 showing the application of a first adhesive flowed into the retentive elements integrated into the surface of base 30 and cured.

FIG. 3 is a section view similar to FIG. 2 showing the application of a second adhesive atop the first adhesive previously cured in the retentive elements of the base 30.

FIG. 4 is a graphic display comparing the relative shear bond strengths using several dental brackets.

### DETAILED DESCRIPTION OF THE INVENTION

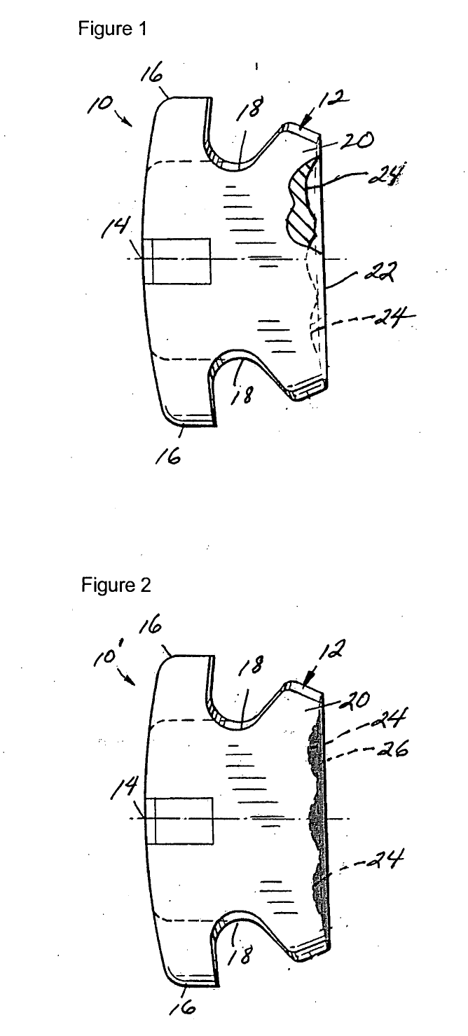

Referring now to the drawings, a typical dental appliance or bracket used is orthodontics is there shown typically at numeral 10 in FIGS. 1 to 3. This dental bracket 10 includes a main body 12 having a central longitudinal groove 14 for receiving an arch wire (not shown) of a typical dental brace installation and further includes upper and lower tie wings 16 defining wire tie-down grooves 18. A bond base 20 is integrated with the main body 12, which has a tooth-facing surface 22 with retentive elements.

As seen in FIG. 2, a first adhesive 26 of relatively low viscosity as described in more detail herebelow is applied and flowed into the retentive element array 24 and there cured to form the bracket 10′. These retentive elements may alternately be formed as by etching, microscopic roughness, by undercut, by pockets, and other indentations. Both mechanical and chemical bonding of this first adhesive layer 26 is thereby accomplished.

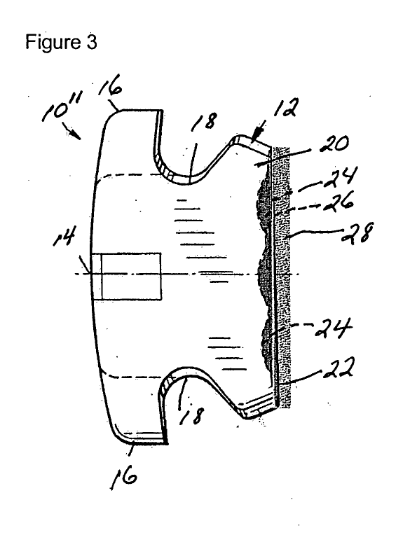

In FIG. 3, a second adhesive shown generally at 28 and being of higher viscosity than that of the first adhesive 26 as described more fully herebelow, is then applied atop of the first cured adhesive 26 after which the fully prepasted dental bracket shown at 10″ is placed in storage in an air and light-tight container or package for later installation. These pre-cemented brackets 10″ can be bonded to teeth using any dental curing light such as a PAC light, a suitable blue-laser light for curing composites, or any halogen light.

The present invention is aimed specifically for the mesh of U.S. Pat. No. 4,889,485. It is known that the TRANSBOND XT adhesive noted in U.S. 2005/0136370 is much too viscous for the mesh of some orthodontic appliances where the mesh is much finer, as fine as 400 mesh with opening of about 38 μm. The present patent application was designed to overcome this problem of mesh or undercut penetration. In U.S. Pat. No. '485, a multi-layer mesh is described which is also depicted in the present application. The mesh size in this patent is as fine as 400 mesh, which is a much finer opening or undercut than found with other devices such as the Victory Brackets or the TRANSCEND ceramic brackets cited by Brennan. The difficulties of mesh penetration are much higher for brackets with this patented mesh. The finer mesh increases the undercut area and the metal-adhesive bonding area.

It is essential to use a very low-viscosity material for a fine mesh bracket or for any device with undercuts. Furthermore, it is essential to avoid any pores on the surface of the bracket with the adhesive and the low viscosity materials described in the present application achieves that goal. If the pores are present, the bonding strength is effectively reduced.

The present patent application uses materials that were developed for use as dental restoratives, but much to our surprise, were suitable for orthodontic adhesives. In particular, the materials have viscosities, both lower and much higher than material used conventionally in orthodontics.. These restorative materials were not designed with a compromised adhesive viscosity to suit both mesh penetration and application to the tooth. The combination of the materials, one cured, achieves the goals which cannot be separately achieved for one composition of material.

Furthermore, the dental restorative material was designed to quickly cure and develop their strength quickly, so that a tooth could be quickly filled and then polished by a dentist. This quick curing can be very suitable for orthodontics where many appliances must be cured as quickly as possible. Also, the fast strength development is very useful for the application of force (an orthodontic wire) to the bracket as soon as it is applied to a tooth.

### Mesh Size/Viscosity

The underside of orthodontic appliances is usually mesh on metal brackets and undercuts on ceramic brackets. The mesh size has been specified for some brackets as 170 to 400 mesh, but may be as low as 80 mesh (180μm). 170 mesh has openings of about 75 μm and 400 mesh has openings about 38 μm.

Tests were conducted to see what the appropriate range of viscosities was for penetrating the mesh, but without having the adhesive pool or flow out of either a 170 mesh or 400 mesh. Lower viscosities are more effective in the 400 mesh than the 170 mesh, as would be expected. The viscosity must be more than 1.4 Pa·s in viscosity and preferably 300 Pa·s or less for mesh penetration without pooling. Less preferably the viscosity can be up to 100 Pa·s. For the 400 mesh brackets, a viscosity of 300 Pa·s is preferred; for larger mesh bracket bases, the high viscosities may be used but are not preferable.

Tests were also conducted to see what viscosity of material was acceptable for application to a tooth without drifting of the brackets before curing. The viscosity must be higher than 1200 (preferably 2000) Pa·s for the bracket to not drift on the tooth and a viscosity of up to 45,000 Pa·s is also acceptable. Therefore, any one orthodontic adhesive can only compromise on the properties, but the use of two adhesives of differing viscosities is more effective. Furthermore, the curing of one adhesive before the application to the teeth enables the practitioner to more quickly apply stresses to the brackets (with the corrective wires) because less adhesive needs to cure and strengthen on the patient in the dental chair.

Direct Orthodontic Bonding Technique

A flowable compomer material used for restorative dentistry is preferably used as the first adhesive 26 to very completely penetrate the retentive elements 24. One such compomer has a brand name of DYRACT FLOW material from Dentsply DeTrey, although others are also known such as Compoglass Flow from Vivadent. DYRACT FLOW material is part glass ionomer and part resin dental composite material and is known as a flowable compomer. This restorative material has excellent physical qualities, which permit ease of flowing the compomer into complex tooth restorations or Class V tooth preparations. Its flowability also is excellent to penetrate in and around the mesh and/or undercut designs of orthodontic-appliances.

Glass ionomer cements are known to chemically bond to stainless steel. When combined into a compomer with resin materials, the result is, for the first time, a chemical bond to the stainless steel appliances with mechanical adhesion. Thus, DYRACT FLOW material achieves mechanical and chemical bonding to the stainless steel mesh or undercut designs. Glass ionomer cements such as Fuji IX GP from Fuji, Vitremer from 3M/ESPE, or C&B cement from Bisco, or flowable resin composites such as DenFil from Vericom, FloRestore from Den-Mat; Revolution 2 from Kerr or Starflow from Danville may also be used.

The DYRACT FLOW material is placed over the base 20 of the orthodontic appliance 10 completely penetrating the roughness, undercuts, mesh, or any retentive element of an appliance and light cured. This process is accomplished in a manufacturing setting, or by a clinician, clinical assistant or orthodontic laboratory technician. The glass ionomer component of the cement can absorb water and begin to chemically cure, or alternatively, an actinic light source can be used to initiate the curing of this layer.

The DYRACT FLOW material or its alternatives may be covered with another light-curable resin material—such as (1) a tooth bonding agent such as Prime and Bond NT or ProBOND bonding agent, or (2) a composite material such as TPH or TPH3 MICRO MATRIX RESTORATIVE or ESTHETX flow or ESTHETX composite. Prime and Bond NT adhesive is a recently developed material manufactured by Dentsply Caulk. If this material or a similar bonding agent is applied, later a high viscosity composite resin material must be applied before bonding to the tooth. TPH or TPH3 MICRO MATRIX RESTORATIVE or ESTHETX or ESTHETX flow are composites dental resin restorative materials made by Dentsply Caulk. A small amount of any of these composite materials placed over the cured DYRACT FLOW material will chemically bond to the DYRACT FLOW material when it is cured. TPH or TPH3 MICRO MATRIX RESTORATIVE or ESTHETX or ESTHETX Flow composite are much less flowable than DYRACT FLOW material, and possess the ideal physical qualities for accurately placing orthodontic brackets onto teeth. ESTHETX FLOW composite has the lowest viscosity and the greatest flow of these three materials. Alternative resin cements with suitable high viscosity and light-curable are Fuji Lining LC by Fuji, or for a slightly more flowable material, Master-Dent by DentalConnection.

In this invention, the pre-cemented brackets are prepared with DYRACT FLOW material on the appliances' surfaces for bonding and then the material is cured. A tooth-bonding agent may be applied in an actinic-light-free environment. Afterwards, a small amount of TPH or TPH3 MICRO MATRIX RESTORATIVE or ESTHETX composite is applied to the appliance in an environment free of actinic radiation. These appliances are stored before use in a suitably light-protected container for later use.

For placement, the clinical orthodontist will clean and etch the tooth, then place a bonding agent on the tooth such as Prime and Bond NT bonding agent. The pre-cemented bracket is placed on the area prepared on the tooth. The composite on the pre-cemented bracket will chemically and mechanically bond to etched and prepared tooth structure. The composite on the appliance is easily positioned onto the teeth and does not drift from the placed position. Alternatively, the ESTHETX FLOW restorative material may be used in place of the TPH or TPH3 micro matrix restorative or ESTHETX composite on the appliance. ESTHETX FLOW composite is a micro-hybrid material, which also forms an excellent bond to teeth. ESTHETX FLOW has more flow (less viscosity) than TPH or TPH3 MICRO MATRIX RESTORATIVE composite, but more viscosity than DYRACT FLOW. This quality of ESTHETX FLOW is useful to place this material onto the tooth in the indirect orthodontic bracket technique described below.

Indirect Orthodontic Bonding Technique

Some clinicians are proponents of the indirect technique where the appliances are placed on a model of the patient's teeth and then transferred to the patient's mouth. Normally, in this case, the appliances are “buttered” with cement and placed on the model to set. The appliance's tooth-facing surface now has the shape or form of the patient's tooth in the cured cement. A “tray” is formed around the brackets on the model and the tray is used to remove the “set” brackets to be transferred to the patient's mouth. A small amount of cement is applied to the set brackets before they are placed as a group onto the patient's teeth by insertion of the tray. This cement will bond to the customized tooth-facing surface of the device and also the tooth. This application of dental restorative is allowed to set, either by light-curing or self-curing inter-orally. Then the tray that held the brackets in place is removed.

In this invention, the appliances must adhere to the model after curing well enough to allow a device to be formed over them to transfer to a patient's mouth. However, the appliances must not adhere to the model so well that they cannot be removed, or that small pieces of the model are removed when the appliance is separated from the model. For the former, an unfilled resin adhesive may be used. The unfilled resin adhesive may be PRIME & BOND NT, ProBOND, or SEAL & PROTECT resin-based products. The resin-based material need not be light-cured before the appliance is applied to the model over the resin-based material. A separating liquid is applied to the model to help remove the bracket from the model for the latter situation. A model of the teeth is prepared and the buccal/labial or lingual surfaces are coated wherever the appliance is to be bonded with a thin layer of a separating liquid. The separating liquid is preferably soluble in water. Past separating liquids have been made of liquids such as mineral oil, or methyl ethyl ketone and butyl acetate. The separating liquid of this invention is composed all or partially of polyvinyl alcohol, glycerin, silica sol, and/or silica gel in water.

In this invention, the pre-cemented brackets are prepared with DYRACT FLOW material on and in the appliances' surfaces for bonding and then the material is cured. Afterwards, a small amount of TPH, TPH3, ESTHETX or ESTHETX FLOW composite is applied to the appliance in an actinic-light-free environment. These appliances are stored before use in a suitably light-protected container for later use.

The two-layer, pre-cemented appliances are placed onto the model and cured. A tray is formed over the cemented appliances, usually by vacuum thermoforming a plastic sheet over the model. The plastic sheet of the tray must be sufficiently closely formed to ensure that the appliances will be accurately transferred into the patient's mouth without movement, but must be pliable enough to allow the release of the appliances when positioned inter-orally. The plastic sheet preferably is quite clear and transmits actinic radiation. Often a more pliable material such as MEMOSIL by Heraeus-Kulzer or another pliable silicone material must be placed over the protruding design elements of the orthodontic appliances to prevent the hooks or other elements from getting embedded in the tray. This more pliable material must be removable from the appliances by its elasticity or by tearing, and should not bond to the tray material. If necessary, the model and tray is placed in water. The water-soluble separating liquid allows removal of the positioned appliances in the tray. At another time, the patient is in the dental office and each of the teeth are etched and a dental primer is applied, such as Prime and Bond NT bonding agent. Next, a small amount of composite material such as ESTHETX Flow composite is placed on the surfaces over the cured composite of each appliance in the tray. The tray with the orthodontic appliances is placed into the patient's mouth and cured in situ. This system reduces chair time and bonding failures for orthodontic brackets and tubes, and makes it easier for clinicians to accurately apply dental appliances. Furthermore, the components of the system enhance the bonding of the appliance to the cement.

The dental materials are non-toxic and hardenable organic resins having sufficient strength and hydrolytic resistance and include such resins as acrylate, methacrylate, di-methacrylate, and urethane. Urethane modified Bis-GMA di-methacrylate (UDMA), diglycylmethacrylate (Bis-GMA), and triethyleneglycol dimethacrylate (TEGDMA) are common. Initiators of polymerization include camphorquinone, dimethylaminophenethanol. Fillers are commonly included to adjust the viscosity and color of such resins and add radiopacity including fumed silica, radiopaque glass, titania, or other glass or ceramic powders.

### EXAMPLE A

Twelve extracted teeth were autoclaved for testing and cleansed using a Danville Engineering micro-etcher filled with Ortho-Prophy SA-85 powder. The powder was sprayed at each tooth for two, separate, two-second applications to thoroughly clean the enamel surface. This treatment was followed by rinsing, the application of a 35% phosphoric acid gel etchant for six seconds, and thorough rinsing with a water spray. Each tooth was suction-dried to dry the surface of the tooth. Prime & Bond NT bonding agent was applied to the tooth following the manufacturer's instructions for application and curing. The Prime & Bond NT material was cured with an Elite Apollo 95E PAC dental curing light.

MYSTIQUE alumina ceramic orthodontic brackets were pre-cemented by applying DYRACT FLOW compomer into the base by hand with a micro-brush. The DYRACT FLOW material was cured with the Apollo light. Afterwards, either ESTHETX FLOW resin composite or TPH composite was applied to the surface of the cured DYRACT FLOW. These brackets were placed on the prepared teeth and the materials were cured with a Elite Apollo 95E PAC curing light.

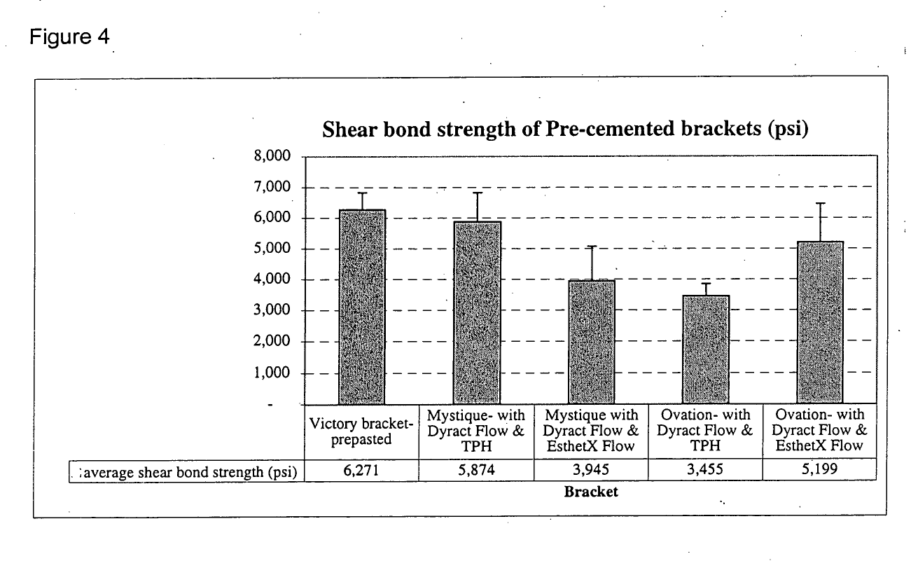

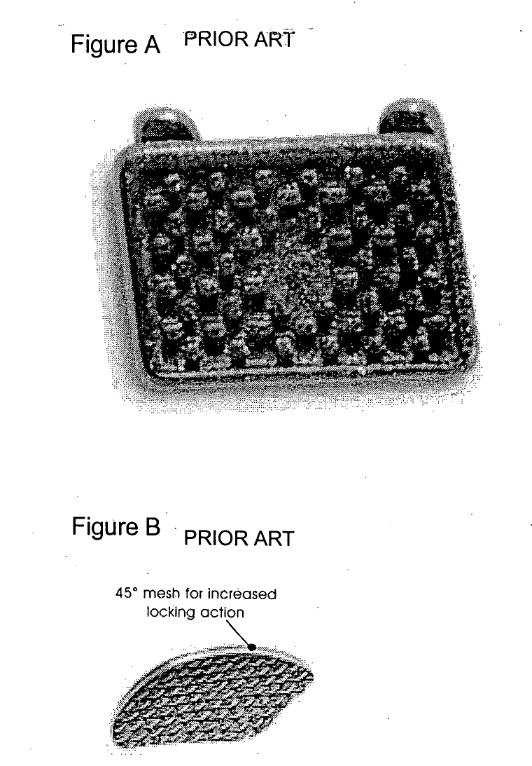

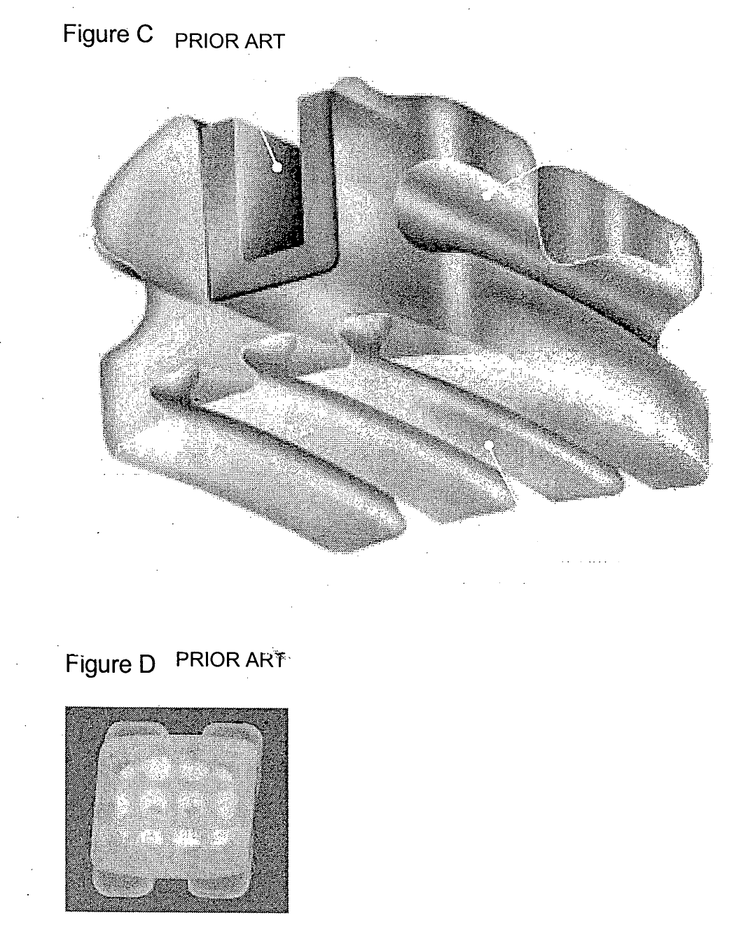

After bonding, the brackets were sheared off the teeth using a universal test machine. The shear bond strength with ESTHETX FLOW composite as shown in FIG. 4, averaged 5,874 psi with a range from 2,100 to 8,300 psi. For the TPH composite, the shear bond strength was 3,945 on average with a range of 2,500 to 4,400 psi. This test was repeated using the OVATION dental bracket producing average shear strength of 3,455 psi and 5,199 psi using the DRYACT FLOW with TPH and ESTHETX FLOW, respectively.

### EXAMPLE B

Autoclaved, extracted bicuspid teeth were cleansed for testing using Danville Engineering micro-etcher filled with Ortho-Prophy SA-85 powder. The powder was sprayed at each tooth for two, separate, two-second applications to thoroughly clean the enamel surface. This treatment was followed by rinsing, the application of a 35% phosphoric acid gel for six seconds, and thorough rinsing with an water spray. Each tooth was suction-dried to dry the surface of the tooth. Prime & Bond NT bonding agent was applied to the tooth following the manufacturer's instructions for application and curing. The Prime & Bond NT material was cured with an Elite Apollo 95E PAC dental curing light.

Next, Unitek/3M Victory pre-pasted brackets were pressed onto the surface of the teeth and light-cured into position. After bonding, the brackets were sheared off the teeth using a universal test machine. The shear bond strengths had an average of 6,271 psi with a range from 4,900 to 7,600 psi.

Constituent Physcial Features

To summarize, the relatively low viscosity of the DYRACT FLOW is approximately 300 Pa·s while the relatively high viscosity of the TPH composite is approximately 5,000 Pa·s. The viscosity of the ESTHETX FLOW lies between that of the DRYACT FLOW and the TPH composite. ESTHETX FLOW is highly thixotropic in that it does not slump and forms peaks similar to that of petroleum jelly when under a low shear field, but flows rather easily under a high shear field such as when a user is pushing it around or forcing it through a cannula.

A general description of each of the constituent restorative materials is as follows:
DYRACT FLOW—Compomer
PRIME & BOND NT—Bonding agent
ESTHETX—Composite restorative
ESTHETX FLOW—Composite restorative
TPH—Composite restorative
TPH3 —Micro Matrix Composite restorative

While the instant invention has been shown and described herein in what are conceived to be the most practical and preferred embodiments, it is recognized that departures may be made therefrom within the scope of the invention, which is therefore not to be limited to the details disclosed herein, but is to be afforded the full scope of the claims so as to embrace any and all equivalent apparatus and articles.

1. An orthodontic appliance comprising:
a main body having a tooth-facing surface having retentive elements and a first dental restorative applied on said tooth-facing surface retentive elements and cured, said first dental restorative before curing having a very low viscosity of in the range of 1.4 to 1000 pascal-seconds (Pa·s) thereby being capable of completely penetrating into said retentive elements, said first dental restorative, after being cured, providing a high bondable surface for receiving a second dental restorative;
said second dental restorative applied over said cured first dental restorative and remaining uncured, said second dental restorative having a very high viscosity of in the range of 2000 to 5000 pascal·seconds (Pa·s), substantially higher than that of said first dental restorative, wherein said appliance is capable of being held on a tooth surface without drifting by said second dental restorative just prior to being cured.

2. An orthodontic appliance as set forth in claim 1 wherein:
said first dental restorative has a viscosity of about 300 Pa·s;
said second dental restorative has a viscosity of about 5000 Pa·s.

3. An orthodontic appliance as set forth in claim 2, wherein:
said first dental restorative has a viscosity sufficient to fully penetrate into and fill the retentive elements without pooling or flowing therefrom prior to curing thereof.

4. An orthodontic appliance as set forth in claim 3, wherein:
the retentive elements have a mesh size in the range of 80 mesh (180μm) to 400 mesh (38μm).

5. In a factory-made orthodontic appliance including a main body having a bonding surface with retentive elements disposed over a tooth-facing surface of said bonding surface, the improvement comprising:
a first dental restorative applied on said retentive elements and there cured, said first dental restorative having a very low viscosity of in the range of 1.4 to 1000 pascal·seconds (Pa·s) thereby being capable of penetrating into said retentive elements without physical force, wherein said first dental restorative completely penetrates into said retentive elements, said first dental restorative being cured in said retentive elements such that a second dental restorative readily adheres to said cured first dental restorative;
said second dental restorative applied over said cured first dental restorative and remaining uncured, said second dental restorative having a very high viscosity of in the range of 2000 to 5000 pascal·seconds (Pa·s), substantially higher than that of said first dental restorative, wherein said appliance is capable of being held on a tooth surface without drifting by said second dental restorative just prior to being cured.

6. The factory-made appliance of claim 5, wherein:
said first dental restorative has a viscosity of about 300 Pa·s;
said second dental restorative has a viscosity of about 5000 Pa·s.

7. The factory-made appliance as set forth in claim 5, wherein:
said first dental restorative has a viscosity sufficient to fully penetrate into and fill the retentive elements without pooling or flowing there prior to curing thereof.

8. The factory-made appliance as set forth in claim 7, wherein:
the retentive elements have a mesh size in the range of 80 mesh (180μm) to 400 mesh (38μm).

9. A method of preparing a ready-to-install orthodontic appliance having a main body with a bonding surface and retentive elements disposed over a tooth-facing surface of said appliance base, comprising the steps of:
a. applying an uncured first dental restorative into said retentive elements, said first dental restorative being a very low viscosity dental restorative capable of penetrating into said retentive elements, said first dental restorative prior to curing thereof having a viscosity in the range of 1.4 to 1000 pascal·seconds (Pa·s), such that a second dental restorative readily adheres to said first cured dental restorative;
b. curing said first dental restorative in said retentive elements to create a highly bondable surface for receiving and being bonded to by a second dental restorative;
c. applying said second dental restorative over said cured first dental restorative, said second dental restorative having a very high viscosity in the range of 2000 to 5000 pascal·seconds (Pa·s) substantially higher than that of said first dental restorative, wherein said appliance is held on a tooth surface just prior to being cured without drifting.

10. The method of claim 9, wherein:
said first dental restorative has a viscosity of about 300 Pa·s;
said second dental restorative has a viscosity of about 5000 Pa·s.

11. The method of claim 10, wherein:
said first dental restorative has a viscosity sufficient to fully penetrate into and fill the retentive elements without pooling or flowing from the retentive elements prior to curing thereof.

12. The method of claim 11, wherein:
the retentive elements have a mesh size in the range of 80 mesh (180 μm) to 400 mesh (38 μm).

13. The method of claim 9, further comprising the steps of:
d. positioning said appliance against a prepared dental model of the tooth surface and curing said second dental restorative to create a custom base for said appliance;
e. removing said appliance from the dental model;
f. applying an adhesive to said custom base, and positioning and holding said appliance against the tooth surface;
g. curing said adhesive.

14. An orthodontic appliance comprising:
a main body including a tooth-facing surface having retentive elements;
a first dental restorative applied uncured on said retentive elements, said first dental restorative before being cured having a very low viscosity sufficient to fully penetrate into and fill the retentive elements without pooling or running from the retentive elements prior to curing thereof, said first adhesive composition being cured in said retentive elements wherein a second dental restorative having a viscosity in a range of 1000 to 5000 pascal-seconds (Pa·s), substantially higher than that of said first dental restorative, is capable of holding said appliance against a tooth surface without drifting just prior to being cured.

15. The orthodontic appliance of claim 14, wherein:
said first dental restorative has a viscosity in the range of 1.4 to 300 Pa·s .

16. The orthodontic appliance of claim 14, wherein:
the retentive elements have a mesh size of in the range of 80 mesh (180 μm) to 400 mesh (38 μm).
